(19) United States
(12) Patent Application Publication
(10) Pub. No.: US 2025/0008598 A1
(43) Pub. Date: Jan. 2, 2025

(54) ENERGY SAVING OPERATIONS IN A WIRELESS COMMUNICATION SYSTEM

(71) Applicant: Samsung Electronics Co., Ltd., Suwon-si (KR)

(72) Inventors: Anil Agiwal, Allen, TX (US); Shiyang Leng, Allen, TX (US); Kyeongin Jeong, Allen, TX (US)

(21) Appl. No.: 18/735,000

(22) Filed: Jun. 5, 2024

Related U.S. Application Data
(60) Provisional application No. 63/523,838, filed on Jun. 28, 2023.

(51) Int. Cl. H04W 76/28

(52) U.S. Cl. CPC H04W 76/28

(57) ABSTRACT

Methods and apparatuses for energy saving operations in a wireless communication system. A method of a UE comprises: receiving, from a base station, an RRC message indicating (i) a payload size of cell DTX/DRX activation/deactivation DCI for at least one cell group and (ii) a starting position of a cell DTX/DRX information for at least one cell in DCI; receiving the cell DTX/DRX activation/deactivation DCI; identifying the cell DTX/DRX information for the at least one cell in the DCI based on (i) the payload size of the cell DTX/DRX activation/deactivation DCI corresponding to the at least one cell group and (ii) the starting position of the cell DTX/DRX information corresponding to the at least one cell; and activating or deactivating a cell DTX/DRX configuration of the at least one cell based on the identified cell DTX/DRX information in the cell DTX/DRX activation/deactivation DCI.

### CROSS-REFERENCE TO RELATED APPLICATIONS AND CLAIM OF PRIORITY

The present application claims priority to U.S. Provisional Patent Application No. 63/523,838, filed on Jun. 28, 2023. The contents of the above-identified patent documents are incorporated herein by reference.

### TECHNICAL FIELD

The present disclosure relates generally to wireless communication systems and, more specifically, the present disclosure relates to an energy saving operations in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to an energy saving and beam failure recovery operation in a wireless communication system.

In one embodiment, a user equipment (UE) in a wireless communication system is provided. The UE comprises a transceiver configured to: receive, from a base station, a radio resource control (RRC) message indicating (i) a payload size of cell discontinuous transmission/reception (DTX/DRX) activation/deactivation downlink control information (DCI) for at least one cell group and (ii) a starting position of a cell DTX/DRX information for at least one cell in DCI, and receive, from the base station, the cell DTX/DRX activation/deactivation DCI. The UE further comprises a processor operably coupled to the transceiver, the processor configured to: identify the cell DTX/DRX information for the at least one cell in the DCI based on (i) the payload size of the cell DTX/DRX activation/deactivation DCI corresponding to the at least one cell group and (ii) the starting position of the cell DTX/DRX information corresponding to the at least one cell, and activate or deactivate a cell DTX/DRX configuration of the at least one cell based on the identified cell DTX/DRX information in the cell DTX/DRX activation/deactivation DCI.

In another embodiment, a method a UE in a wireless communication system is provided. The method comprises: receiving, from a base station, an RRC message indicating (i) a payload size of cell DTX/DRX activation/deactivation DCI for at least one cell group and (ii) a starting position of a cell DTX/DRX information for at least one cell in DCI; receiving, from the base station, the cell DTX/DRX activation/deactivation DCI; identifying the cell DTX/DRX information for the at least one cell in the DCI based on (i) the payload size of the cell DTX/DRX activation/deactivation DCI corresponding to the at least one cell group and (ii) the starting position of the cell DTX/DRX information corresponding to the at least one cell; and activating or deactivating a cell DTX/DRX configuration of the at least one cell based on the identified cell DTX/DRX information in the cell DTX/DRX activation/deactivation DCI.

In yet another embodiment, a BS in a wireless communication system is provided. The BS comprises a processor configured to generate cell DTX/DRX activation/deactivation DCI and a cell DTX/DRX information. The BS further comprises a transceiver operably coupled to the processor, the transceiver configured to: transmit, a UE, an RRC message indicating (i) a payload size of cell DTX/DRX activation/deactivation DCI for at least one cell group and (ii) a starting position of a cell DTX/DRX information for at least one cell in DCI, and transmit, to the UE, the cell DTX/DRX activation/deactivation DCI, wherein the cell DTX/DRX information is identified for the at least one cell in the DCI based on (i) the payload size of the cell DTX/DRX activation/deactivation DCI corresponding to the at least one cell group and (ii) the starting position of the cell DTX/DRX information corresponding to the at least one cell, and wherein cell DTX/DRX configuration of the at least one cell is activated or deactivated based on the identified cell DTX/DRX information in the cell DTX/DRX activation/deactivation DCI.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIGS. 6 to 8 illustrate examples of signaling flow for an energy saving and beam failure recovery operation according to embodiments of the present disclosure;

FIG. 9 illustrate an example of terminating a non-active period according to embodiments of the present disclosure;

FIG. 10 illustrates a flowchart of a UE method according to embodiments of the present disclosure; and

FIG. 11 illustrates a flowchart of a method for an energy saving and beam failure recovery operation according to embodiments of the present disclosure.

### DETAILED DESCRIPTION

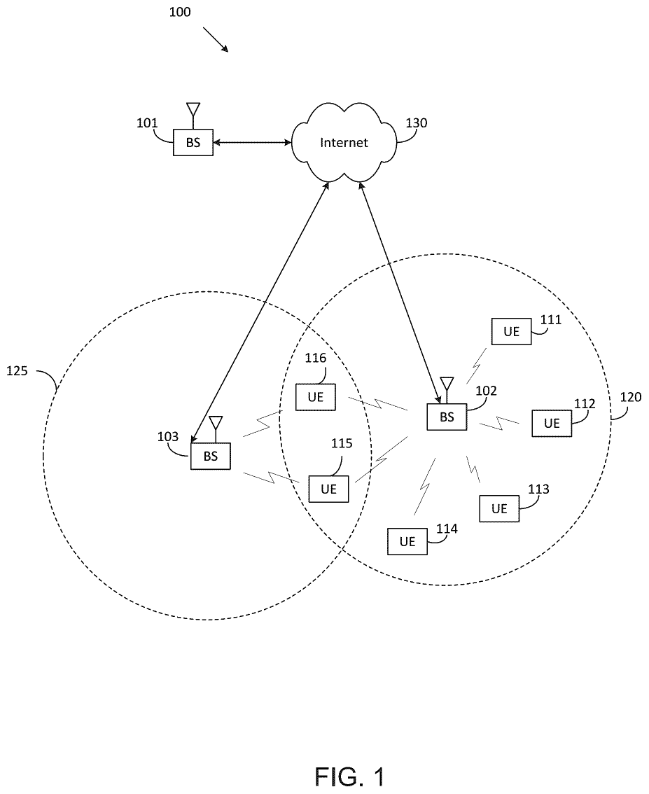

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for an energy saving operations in a wireless communication system. In certain embodiments, and one or more of the gNBs 101-103 includes circuitry, programing, or a combination thereof, to support an energy saving operations in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

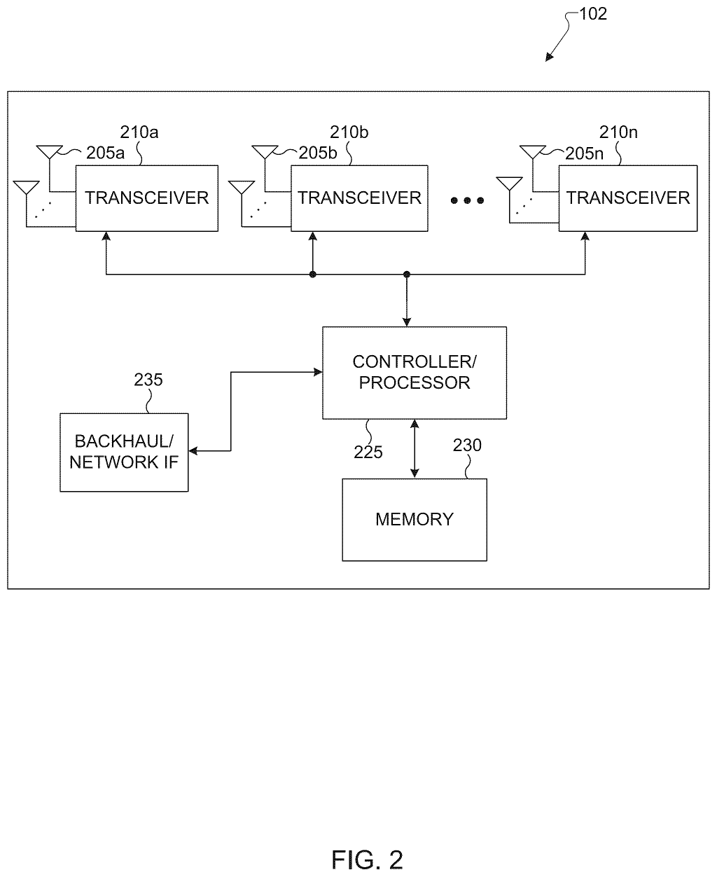

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process. The controller/processor 225 is also capable of executing programs and other processes resident in the memory 230, such as processes to support energy saving operations in a wireless communication system.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

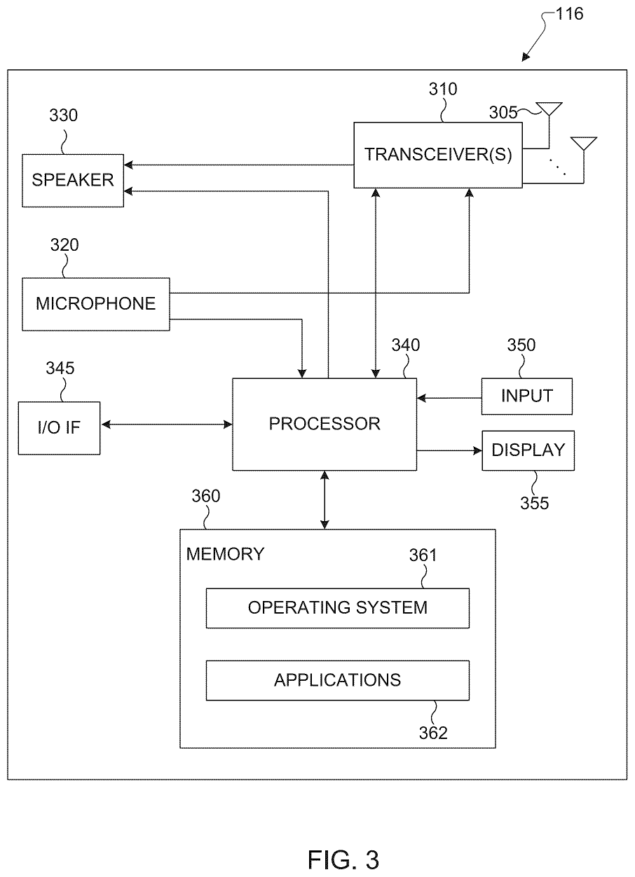

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for energy saving operations in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc. . . . , and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

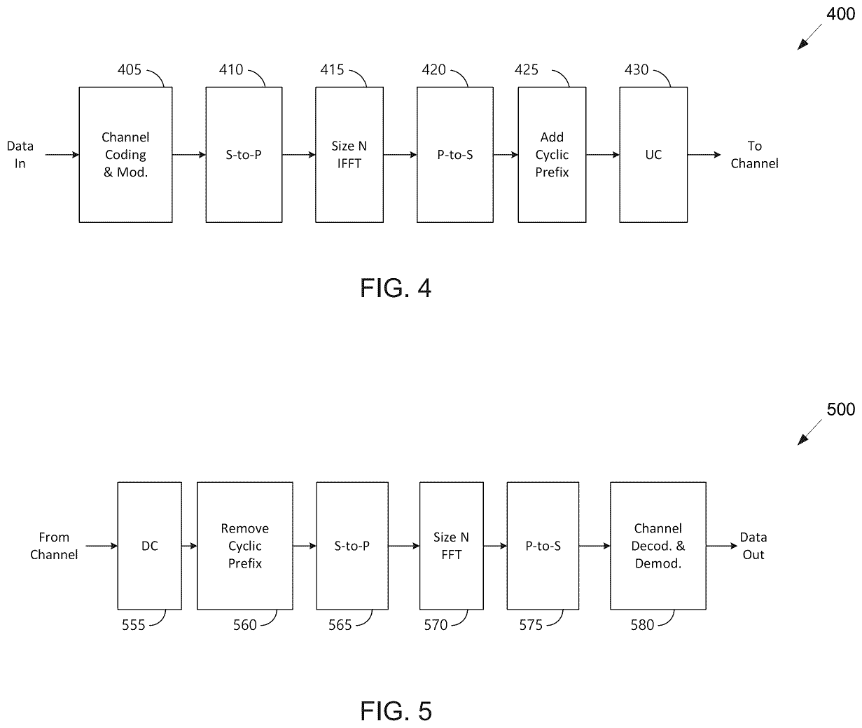

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the transmit path 400 is configured for an energy saving operations in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIGS. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

Wireless communication system supports a standalone mode of operation as well as a dual connectivity (DC). In DC, a multiple Rx/Tx UE may be configured to utilize resources provided by two different nodes (or NBs) connected via a non-ideal backhaul. One node acts as a master node (MN) and the other node acts as a secondary node (SN). The MN and SN are connected via a network interface and at least MN is connected to the core network. NR also supports a multi-RAT dual connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e. if the node is a gNB).

In NR, a UE in an RRC_CONNECTED state is not configured with CA/DC and there is only one serving cell comprising a primary cell. When a UE in an RRC_CONNECTED state is configured with CA/DC, the term “serving cells” are used to denote a set of cells comprising the special cell(s) and all secondary cells. In NR, a master cell group (MCG) refers to a group of serving cells associated with the master node comprising a PCell and optionally one or more SCells.

In NR, secondary cell group (SCG) refers to a group of serving cells associated with the secondary node comprising the PSCell and optionally one or more SCells. In NR, a PCell (primary cell) refers to a serving cell in MCG, operating on the primary frequency, in which the UE either performs an initial connection establishment procedure or initiates a connection re-establishment procedure. In NR, for a UE configured with CA, a Scell is a cell providing additional radio resources on top of special cell.

A primary SCG Cell (PSCell) refers to a serving cell in SCG in which a UE performs a random access when the UE performs a reconfiguration with sync procedure. For a dual connectivity operation, a SpCell (i.e., special cell) refers to a PCell of a MCG or a PSCell of a SCG, otherwise a special cell refers to a PCell.

In the wireless communication system, node B (gNB) or base station in cell broadcast Synchronization Signal and PBCH block (SSB) consists of primary and secondary synchronization signals (PSS, SSS) and system information. System information includes common parameters needed to communicate in cell.

In the wireless communication system, random access (RA) is supported. Random access (RA) is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by non-synchronized UE in RRC CONNECTED state. Several types of random-access procedure are supported such as contention based random access, contention free random access and each of these can be one of 2 step or 4 step random access.

In the wireless communication system, Physical Downlink Control Channel (PDCCH) is used to schedule DL transmissions on PDSCH and UL transmissions on PUSCH, where the Downlink Control Information (DCI) on PDCCH includes: Downlink assignments containing at least modulation and coding format, resource allocation, and hybrid-ARQ information related to DL-SCH; Uplink scheduling grants containing at least modulation and coding format, resource allocation, and hybrid-ARQ information related to UL-SCH. In addition to scheduling, PDCCH can be used to for: Activation and deactivation of configured PUSCH transmission with configured grant; Activation and deactivation of PDSCH semi-persistent transmission; Notifying one or more UEs of the slot format; Notifying one or more UEs of the PRB(s) and OFDM symbol(s) where the UE may assume no transmission is intended for the UE; Transmission of TPC commands for PUCCH and PUSCH; Transmission of one or more TPC commands for SRS transmissions by one or more UEs; Switching a UE's active bandwidth part; Initiating a random access procedure.

A UE monitors a set of PDCCH candidates in the configured monitoring occasions in one or more configured COntrol REsource SETs (CORESETs) according to the corresponding search space configurations. A CORESET consists of a set of PRBs with a time duration of 1 to 3 OFDM symbols. The resource units Resource Element Groups (REGs) and Control Channel Elements (CCEs) are defined within a CORESET with each CCE including a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own DMRS. QPSK modulation is used for PDCCH.

In wireless communication system bandwidth adaptation (BA) is supported. With BA, the receive and transmit bandwidth of a UE need not be as large as the bandwidth of the cell and can be adjusted: the width can be ordered to change (e.g. to shrink during period of low activity to save power); the location can move in the frequency domain (e.g. to increase scheduling flexibility); and the subcarrier spacing can be ordered to change (e.g. to allow different services). A subset of the total cell bandwidth of a cell is referred to as a Bandwidth Part (BWP). BA is achieved by configuring RRC connected UE with BWP(s) and telling the UE which of the configured BWPs is currently the active one.

When BA is configured, the UE is configured to monitor PDCCH only on the one active BWP i.e., it does not have to monitor PDCCH on the entire DL frequency of the serving cell. In RRC connected state, UE is configured with one or more DL and UL BWPs, for each configured Serving Cell (i.e., PCell or SCell). For an activated Serving Cell, there is always one active UL and DL BWP at any point in time. The BWP switching for a Serving Cell is used to activate an inactive BWP and deactivate an active BWP at a time. The BWP switching is controlled by the PDCCH indicating a downlink assignment or an uplink grant, by the bwp-Inactivity Timer, by RRC signaling, or by the MAC entity itself upon initiation of Random Access procedure. Upon addition of SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of BWP inactivity timer UE switch to the active DL BWP to the default DL BWP or initial DL BWP (if default DL BWP is not configured).

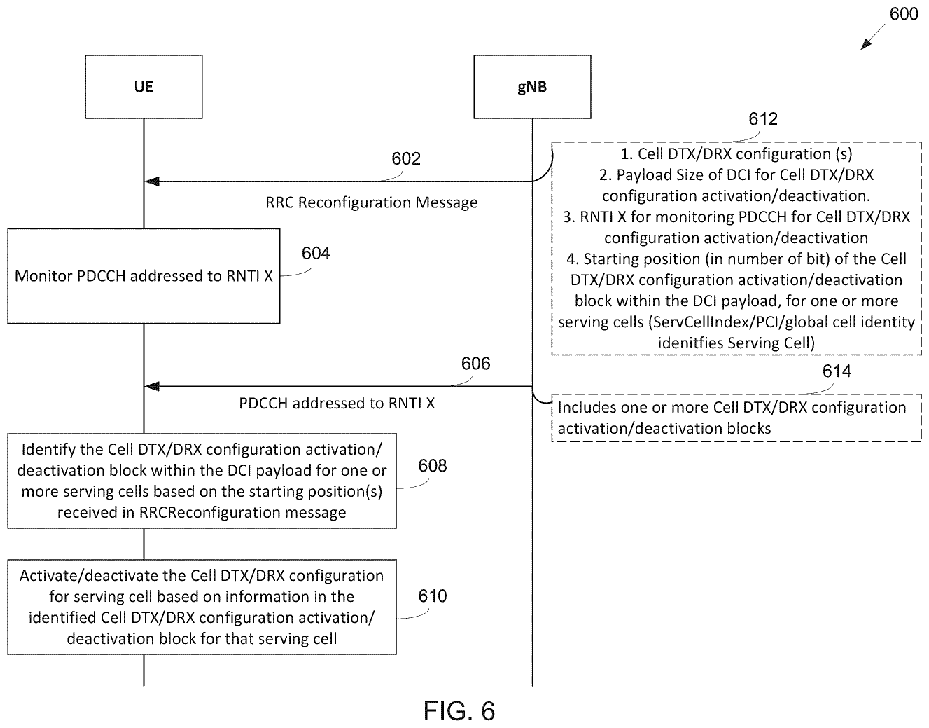

FIGS. 6 to 8 illustrate examples of signaling flows 600 to 800 for an energy saving operation according to embodiments of the present disclosure. The signaling flows 600 to 800 as may be performed by a UE (e.g., 111-116 as illustrated in FIG. 1) and a gNB (e.g., 101-103 as illustrated in FIG. 1). An embodiment of the signaling flows 600 to 800 shown in FIGS. 6 to 8 are for illustration only. One or more of the components illustrated in FIGS. 6 to 8 can be implemented in specialized circuitry configured to perform the noted functions or one or more of the components can be implemented by one or more processors executing instructions to perform the noted functions.

As illustrated in FIG. 6, in step 602, the gNB sends an RRC reconfiguration message to the UE. In step 604, the UE monitors PDCCH addressed to RNTI X. In step 606, the gNB sends a PDCCH addressed to RNTI X to the UE. In step 608, the UE identifies the cell discontinuous transmission/reception (DTX/DRX) configuration activation/deactivation block within the DCI payload for one or more serving cells based on the starting position(s) received in an RRCReconfiguration message. In step 610, the UE activates/deactivates the Cell DTX/DRX configuration for serving cell based on information in the identified cell DTX/DRX configuration activation/deactivation block for that serving cell. In step 612, the gNB identifies: (1) a cell DTX/DRX configuration(s); (2) a payload Size of DCI for Cell DTX/DRX configuration activation/deactivation; (3) RNTI X for monitoring PDCCH for Cell DTX/DRX configuration activation/deactivation; and (4) a starting position (in number of bit) of the Cell DTX/DRX configuration activation/deactivation block within the DCI payload, for one or more serving cells (ServCellIndex/PCI/global cell identity identifies serving cell). In step 614, the gNB includes one or more Cell DTX/DRX configuration activation/deactivation blocks.

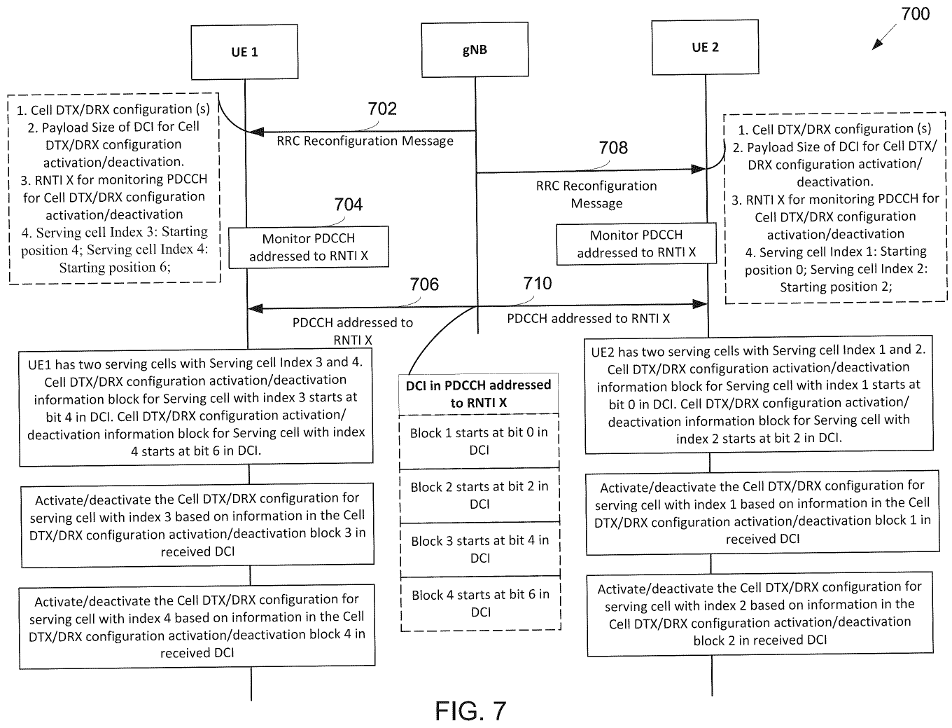

As illustrated in FIG. 7, in step 702, the gNB sends an RRC reconfiguration message to the UE 1. In step 704, the UE 1 monitors PDCCH addressed to RNTI X. In step 706, the gNB sends PDCCH addressed to RNTI X to the UE 1. In step 708, the gNB sends an RRC reconfiguration message to the UE 2. In step 710, the gNB sends PDCCH addressed to RNTI X to the UE 2.

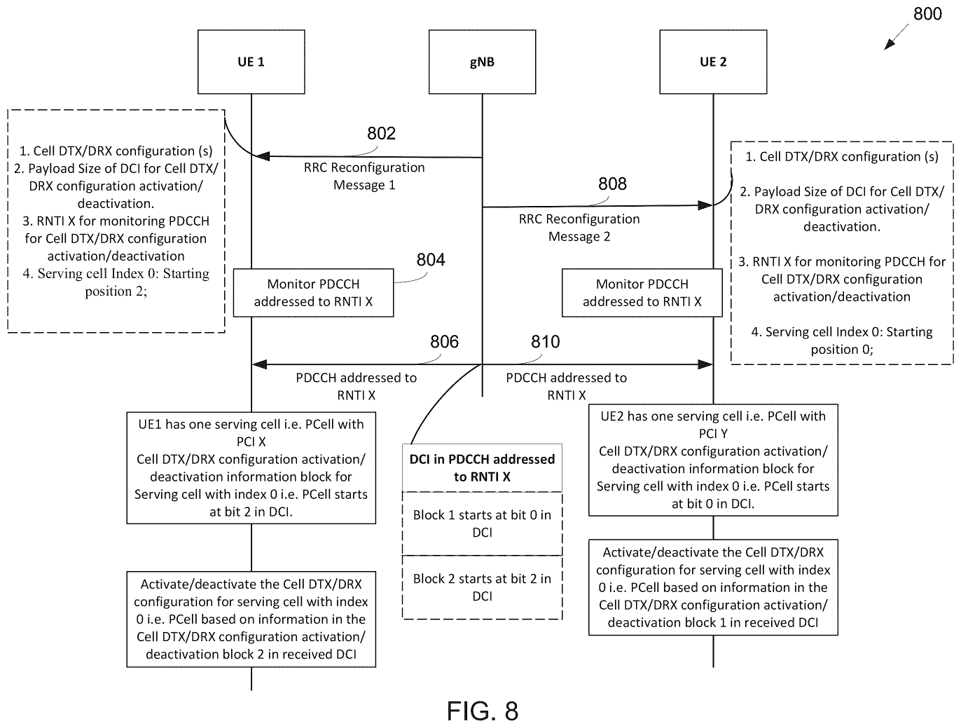

As illustrated in FIG. 8, in step 802, the gNB sends an RRC reconfiguration message 1 to the UE 1. In step 804, the UE 1 monitors PDCCH addressed to RNTI X. In step 806, the gNB sends PDCCH addressed to RNTI X to the UE 1. In step 808, the gNB sends an RRC reconfiguration message 2 to the UE 2. In step 810, the gNB sends PDCCH addressed to RNTI X to the UE 2.

To facilitate a gNB reduce downlink transmission/uplink reception activity, an RRC connected UE can be configured with a periodic cell DTX/DRX pattern (i.e., active and non-active periods). A pattern configuration for cell DRX/DTX is common for the UEs supporting this feature in the cell. The cell DTX and cell DRX can be configured independently. When cell DTX is configured, the UE does not have to continuously monitor PDCCH or SPS occasions during cell non-active periods. When cell DRX is configured, the UE does not transmit on CG resources or transmit a SR during cell non-active periods. This feature is only applied to UEs in an RRC_CONNECTED state and it does not impact RACH, paging, and system information broadcasting. Once the gNB recognizes there is an emergency call or public safety related service (e.g., MPS or MCS), the network should ensure that there is no negative QoS impact to that service (e.g., it may release cell DTX/DRX configuration). In order to activate/deactivate cell DTX/DRX configuration, network can send group common PDCCH.

A periodic cell DTX pattern may be configured by a “duration” and “period” field wherein during the “duration” interval which occurs periodically every “period,” cell does not perform transmission (or stops certain transmissions (e.g., PDSCH, PBCH, SSBs, etc.). Alternately, periodic cell DTX pattern may be configured by a “duration” and “period” field wherein during the “duration” interval which occurs periodically every “period,” cell perform transmission and during the interval “period—duration” cell does not perform transmission (or stops certain transmissions (e.g., PDSCH, PBCH, SSBs, etc. . . . )). The period/time where cell does not perform transmission (or stops certain transmissions (e.g., PDSCH, PBCH, SSBs, etc.) is called inactive period/time.

A periodic cell DRX pattern may be configured by a “duration” and “period” field wherein during the “duration” interval which occurs periodically every “period,” cell does not perform reception (or stops certain receptions e.g., PUCCH, PUSCH, PRACH etc.). Alternately, periodic cell DRX pattern may be configured by a “duration” and “period” field wherein during the “duration” interval which occurs periodically every “period,” cell perform reception and during the interval “period—duration” cell does not perform reception (or stops certain receptions e.g., PUCCH, PUSCH, PRACH etc.). During the cell level DRX duration where network (i.e., base station) does not receive transmission (or certain transmissions) from a UE on the uplink of that cell, the UE does not transmit (or does not transmit) certain transmissions in uplink of that cell. The period/time where cell does not perform reception (or stops certain receptions (e.g., PUCCH, PUSCH, PRACH, etc.) is called inactive period/time.

The group common PDCCH for activation/deactivation of cell DTX/DRX configuration can include multiple cell DTX/DRX activation/deactivation information blocks where in each block at least indicates DTX configuration activation/deactivation and DRX configuration activation/deactivation. The issue is how a UE determines the cell DTX/DRX activation/deactivation information block corresponding to its serving cell. Note that including PCI or cell ID in each block leads to increased overhead and may not be possible due to limited size of DCI. So, enhancement is needed.

Additionally monitoring group common PDCCH can be power consuming for UEs and enhancements such monitoring LP WUS for activation/deactivation can be considered.

Multi transmission/reception point (M-TRP) beam failure detection (BFD) and beam failure recovery (BFR) is supported in 5G wireless communication system. There can be up to two TRPs in a serving cell. BFD/BFR is performed per TRP. Separate BFD-RS set and candidate beam list for each TRP is signaled by RRC. Enhanced BFR MAC CE is transmitted upon BFD for a BFD-RS set of serving cell. For BFR of a BFD-RS set of serving cell, BFR MAC CE includes following information for the failed TRP. AC field (1 bit) indicates candidate beam is available or not. Candidate RS ID (6 bits) field (included if candidate beam is available). BFD-RS set ID (1 bit), to identify the failed TRP. In case of BFD for both BFD-RS sets of SpCell, Contention based Random access procedure is initiated. In case of failure of both TRPs of SpCell, CBRA incur latency in recovery due to contention and also leads to increased energy consumption. Enhancement is needed.

The present disclosure provides: (1) a signaling of starting position of the cell DTX/DRX configuration activation/deactivation (information) block within the DCI payload, for one or more serving cell. Starting position is signaled per ServCellIndex/PCI/global cell identity; (2) an indication of search space for monitoring PDCCH for cell DTX/DRX configuration activation/deactivation; (3) an indication of RNTI for monitoring PDCCH for cell DTX/DRX configuration activation/deactivation; (4) a signaling of separate search space for monitoring PDCCH for cell DTX/DRX configuration in active period and inactive period; (5) a monitoring of PDCCH for cell DTX/DRX configuration activation/deactivation on specific cell (e.g., SpCell); (6) a cell DTX/DRX configuration deactivation or inactive period termination via paging message/paging DCI/short message/SIB/LP WUS; (7) a signaling of 4 step CFRA (Contention free random access) or 2 step CFRA configuration for BFR of both BFD-RS sets of SpCell; (8) RA type selection based on 4 step CFRA (Contention free random access)/2 step CFRA configuration for BFR of both BFD-RS sets of SpCell; (9) RA resource selection based on 4 step CFRA (Contention free random access)/2 step CFRA configuration for BFR of both BFD-RS sets of SpCell; and (10) a determination of msgA-TransMax to apply (note that there can be multiple configurations of msgA-TransMax received from a gNB) during the random access procedure to fallback from 2 step RA to 4 step RA.

A UE is in an RRC_CONNECTED state. The UE receives an RRC reconfiguration message from a gNB. The RRC reconfiguration message is transmitted to the UE by the gNB in dedicated manner. Note that even though message is sent in dedicated manner, some information included in the message can be same for multiple UEs.

An RRC reconfiguration message includes one or more cell DTX/DRX configurations. The cell DTX/DRX configurations can be for one or more cells (or serving cells).

An RRC reconfiguration message includes payload size of DCI for (or which includes information for, or which is used to convey) activation/deactivation of cell DTX/DRX configuration. In one embodiment, this payload size can be separately configured for each cell group (MCG, SCG). In one embodiment, this payload size can be common for all cell groups. In one embodiment, this payload size can be configured per serving cell or per DL BWP of serving cell.

An RRC reconfiguration message includes a specific RNTI (e.g., RNTI X) for monitoring PDCCH for activation/deactivation of cell DTX/DRX configuration. This RNTI can be configured per BWP or per serving cell or common for all serving cells or per cell group or common for all cell groups. In one embodiment, this RNTI is pre-defined and is not included in the RRC reconfiguration message (i.e., not signaled by the gNB).

An RRC reconfiguration message indicates the search space (amongst the list of search space configurations) to be used by a UE for monitoring PDCCH for activation/deactivation of cell DTX/DRX configuration. In one embodiment, this can be indicated by including in search space configuration the DCI_format for activation/deactivation of cell DTX/DRX configuration.

An RRC reconfiguration message include starting position (in number of bit) of the cell DTX/DRX configuration activation/deactivation (information) block within the DCI payload, for one or more serving cells. In one embodiment, a reconfiguration message includes starting position (in number of bit) of the cell DTX/DRX configuration activation/deactivation block within the DCI payload, for one or more ServCellIndex. ServCellIndex identifies serving cell, where ServCellIndex 0 is used for PCell/PSCell. In an alternate embodiment, a reconfiguration message includes starting position (in number of bit) of the cell DTX/DRX configuration activation/deactivation block within the DCI payload, for one or more PCIs. In an alternate embodiment, a reconfiguration message includes starting position (in number of bit) of the cell DTX/DRX configuration activation/deactivation block within the DCI payload, for one or more global cell identity.

In one embodiment, an RRC reconfiguration message includes an offset which the UE adds to signaled starting position to determine the start of the cell DTX/DRX configuration activation/deactivation (information) block within the DCI payload.

In one embodiment, starting position for each (serving) cell is different which means cell DTX/DRX configuration activation/deactivation block is per (serving) cell. In one embodiment, starting position can be same for multiple (serving) cells which means that cell DTX/DRX configuration activation/deactivation block can be associated with one or more cells.

A UE monitors the PDCCH addressed to RNTI X in PDCCH monitoring occasions in search space for monitoring PDCCH for activation/deactivation of cell DTX/DRX configuration. In one embodiment, this monitoring is performed only on (active DL BWP of) SpCell and in this case search space for monitoring PDCCH for activation/deactivation of cell DTX/DRX configuration is provided by a gNB only for SpCell. In one embodiment, this monitoring is performed on one or more serving cells indicated by the gNB. In one embodiment, this monitoring is performed on active DL BWP of serving cell(s) for which search space for monitoring PDCCH for activation/deactivation of cell DTX/DRX configuration is configured. In an alternate embodiment, this monitoring is performed in (active DL BWP of) serving cell for which search space for monitoring PDCCH for activation/deactivation of cell DTX/DRX configuration is provided by the gNB.

In one embodiment, irrespective of cell DTX active or inactive period, a UE monitors the PDCCH addressed to RNTI X in PDCCH monitoring occasions in search space for monitoring PDCCH for activation/deactivation of cell DTX/DRX configuration. In one embodiment, search space configuration to use for monitoring PDCCH for activation/deactivation of cell DTX/DRX configuration can be signaled by a gNB separately for cell DTX inactive period/time and cell DTX active period/time. While monitoring PDCCH in a serving cell for activation/deactivation of cell DTX/DRX configuration, the UE monitors in PDCCH monitoring occasions of search space for cell DTX inactive period/time during the cell DTX inactive period/time. While monitoring PDCCH in a serving cell for activation/deactivation of cell DTX/DRX configuration, the UE monitors in PDCCH monitoring occasions of search space for cell DTX active period/time during the cell DTX active period/time.

A UE receives the PDCCH addressed to RNTI X. The UE identifies the cell DTX/DRX configuration activation/deactivation block(s) within the DCI payload for its serving cell(s) based on the starting position(s) received in an RRCReconfiguration message.

A UE then activates/deactivates the cell DTX/DRX configuration for serving cell(s) based on information in the identified cell DTX/DRX configuration activation/deactivation block for serving cell(s). Note that in case a serving cell is an SCell and is in a deactivated state, the UE may store activation/deactivation information received and use the information when SCell is activated. Bit in cell DTX/DRX configuration activation/deactivation block indicating activation/deactivation can be common for cell DTX and cell DRX. Bit in cell DTX/DRX configuration activation/deactivation block indicating activation/deactivation can be separate for cell DTX and cell DRX. In one embodiment, in addition to cell DTX/DRX configuration activation/deactivation bit(s), cell DTX/DRX configuration activation/deactivation block may include the cell DTX/DRX configuration index (this is useful in case multiple cell DTX/DRX configurations are signaled per serving cell).

A UE 1 and a UE 2 are in an RRC_CONNECTED state.

A gNB transmits an RRC reconfiguration message 1 to the UE 1: (1) the RRC reconfiguration message 1 includes cell DTX/DRX configuration(s); (2) the RRC reconfiguration message 1 includes payload size of DCI for activation/deactivation of cell DTX/DRX configuration; (3) the RRC reconfiguration message 1 includes RNTI X for monitoring PDCCH for activation/deactivation of cell DTX/DRX configuration; (4) the RRC reconfiguration message 1 indicates the search space (amongst the list of search space configurations) used by the UE for monitoring PDCCH for activation/deactivation of cell DTX/DRX configuration; and (5) the RRC reconfiguration message 1 include starting position (in number of bit) of the cell DTX/DRX configuration activation/deactivation block within the DCI payload: serving cell index 3: starting position 4; serving cell index 4: starting position 6 are provided.

A gNB transmits an RRC reconfiguration message 2 to the UE 2: (1) the RRC reconfiguration message 2 includes cell DTX/DRX configuration(s); (2) the RRC reconfiguration message 2 includes payload size of DCI for activation/deactivation of cell DTX/DRX configuration; (3) the RRC reconfiguration message 2 includes RNTI X for monitoring PDCCH for activation/deactivation of cell DTX/DRX configuration; (4) the RRC reconfiguration message 2 indicates the search space (amongst the list of search space configurations) used by the UE for monitoring PDCCH for activation/deactivation of cell DTX/DRX configuration; (5) and the RRC reconfiguration message 2 include starting position (in number of bit) of the cell DTX/DRX configuration activation/deactivation block within the DCI payload: serving cell index 1: starting position 0; serving cell index 2: starting position 2.

The UE 1 receives an RRC reconfiguration message 1 from a gNB. The RRC reconfiguration message is sent to the UE 1 in dedicated manner: (1) the RRC reconfiguration message includes cell DTX/DRX configuration(s); (2) the RRC reconfiguration message includes payload size of DCI for activation/deactivation of cell DTX/DRX configuration; (3) the RRC reconfiguration message includes RNTI X for monitoring PDCCH for activation/deactivation of cell DTX/DRX configuration; (4) the RRC reconfiguration message indicates the search space (amongst the list of search space configurations) used by the UE for monitoring PDCCH for activation/deactivation of cell DTX/DRX configuration; (5) the RRC reconfiguration message include starting position (in number of bit) of the cell DTX/DRX configuration activation/deactivation block within the DCI payload: serving cell index 3: Starting position 4; serving cell index 4: starting position 6; and (6) the UE 1 monitors the PDCCH addressed to RNTI X in PDCCH monitoring occasions in search space for monitoring PDCCH for activation/deactivation of cell DTX/DRX configuration.

The UE 2 receives an RRC reconfiguration message 2 from a gNB. The RRC reconfiguration message is sent to the UE 2 in dedicated manner: (1) the RRC reconfiguration message 2 includes cell DTX/DRX configuration(s); (2) the RRC reconfiguration message 2 includes payload size of DCI for activation/deactivation of cell DTX/DRX configuration; (3) the RRC reconfiguration message 2 includes RNTI X for monitoring PDCCH for activation/deactivation of cell DTX/DRX configuration; (4) the RRC reconfiguration message 2 indicates the search space (amongst the list of search space configurations) used by the UE for monitoring PDCCH for activation/deactivation of cell DTX/DRX configuration; (5) the RRC reconfiguration message 2 include starting position (in number of bit) of the cell DTX/DRX configuration activation/deactivation block within the DCI payload: serving cell index 1: starting position 0; serving cell index 2: starting position 2; and (6) the UE 2 monitors the PDCCH addressed to RNTI X in PDCCH monitoring occasions in search space for monitoring PDCCH for activation/deactivation of cell DTX/DRX configuration.

A gNB transmits PDCCH addressed to RNTI X. The UE 1 and the UE 2 receive the PDCCH addressed to RNTI X. The PDCCH is sent to the UE 1 and the UE 2 in non-dedicated manner: (1) the UE1 has two serving cells with serving cell index 3 and 4. cell DTX/DRX configuration activation/deactivation information block for serving cell with index 3 starts at bit 4 in DCI of PDCCH addressed to RNTI X. cell DTX/DRX configuration activation/deactivation information block for serving cell with index 4 starts at bit 6 in DCI of PDCCH addressed to RNTI X; (2) the UE 1 activates/deactivates the cell DTX/DRX configuration for serving cell with index 3 based on information in the cell DTX/DRX configuration activation/deactivation block 3 in received DCI; (3) the UE 1 activates/deactivates the cell DTX/DRX configuration for serving cell with index 4 based on information in the cell DTX/DRX configuration activation/deactivation block 4 in received DCI; (4) the UE2 has two serving cells with serving cell index 1 and 2. cell DTX/DRX configuration activation/deactivation information block for serving cell with index 1 starts at bit 0 in DCI of PDCCH addressed to RNTI X. cell DTX/DRX configuration activation/deactivation information block for serving cell with index 2 starts at bit 2 in DCI of PDCCH addressed to RNTI X; (5) the UE 2 activates/deactivates the cell DTX/DRX configuration for serving cell with index 1 based on information in the cell DTX/DRX configuration activation/deactivation block 1 in received DCI; and (6) the UE 2 activates/deactivates the cell DTX/DRX configuration for serving cell with index 2 based on information in the cell DTX/DRX configuration activation/deactivation block 2 in received DCI.

The UE 1 and the UE 2 are in an RRC_CONNECTED state. The UE 1 has only one serving cell i.e., PCell with PCI X. The UE 2 has only one serving cell i.e., PCell with PCI Y.

A gNB transmits an RRC reconfiguration message 1 to the UE 1: (1) the RRC reconfiguration message 1 includes cell DTX/DRX configuration(s); (2) the RRC reconfiguration message 1 includes payload size of DCI for activation/deactivation of cell DTX/DRX configuration; (3) the RRC reconfiguration message 1 includes RNTI X for monitoring PDCCH for activation/deactivation of cell DTX/DRX configuration; (4) the RRC reconfiguration message 1 indicates the search space (amongst the list of search space configurations) used by the UE for monitoring PDCCH for activation/deactivation of cell DTX/DRX configuration; and (5) the RRC reconfiguration message 1 include starting position (in number of bit) of the cell DTX/DRX configuration activation/deactivation block within the DCI payload: serving cell index 0: starting position 2.

A gNB transmits an RRC reconfiguration message 2 to the UE 2: (1) the RRC reconfiguration message 2 includes cell DTX/DRX configuration(s); (2) the RRC reconfiguration message 2 includes payload size of DCI for activation/deactivation of cell DTX/DRX configuration; (3) the RRC reconfiguration message 2 includes RNTI X for monitoring PDCCH for activation/deactivation of cell DTX/DRX configuration; (4) the RRC reconfiguration message 2 indicates the search space (amongst the list of search space configurations) used by the UE for monitoring PDCCH for activation/deactivation of cell DTX/DRX configuration; and (5) the RRC reconfiguration message 2 include starting position (in number of bit) of the cell DTX/DRX configuration activation/deactivation block within the DCI payload: serving cell index 0: starting position 0.

The UE 1 receives an RRC reconfiguration message 1 from a gNB. The RRC reconfiguration message is sent to the UE 1 in dedicated manner: (1) the RRC reconfiguration message includes cell DTX/DRX configuration(s); (2) the RRC reconfiguration message includes payload size of DCI for activation/deactivation of cell DTX/DRX configuration; (3) the RRC reconfiguration message includes RNTI X for monitoring PDCCH for activation/deactivation of cell DTX/DRX configuration; (4) the RRC reconfiguration message indicates the search space (amongst the list of search space configurations) used by the UE for monitoring PDCCH for activation/deactivation of cell DTX/DRX configuration; (5) the RRC reconfiguration message include starting position (in number of bit) of the cell DTX/DRX configuration activation/deactivation block within the DCI payload: serving cell index 0: starting position 2; and (6) The UE 1 monitors the PDCCH addressed to RNTI X in PDCCH monitoring occasions in search space for monitoring PDCCH for activation/deactivation of cell DTX/DRX configuration.

The UE 2 receives an RRC reconfiguration message 2 from a gNB. The RRC reconfiguration message is sent to the UE 2 in dedicated manner: (1) the RRC reconfiguration message 2 includes cell DTX/DRX configuration(s); (2) the RRC reconfiguration message 2 includes payload size of DCI for activation/deactivation of cell DTX/DRX configuration; (3) the RRC reconfiguration message 2 includes RNTI X for monitoring PDCCH for activation/deactivation of cell DTX/DRX configuration; (4) the RRC reconfiguration message 2 indicates the search space (amongst the list of search space configurations) used by the UE for monitoring PDCCH for activation/deactivation of cell DTX/DRX configuration; (5) the RRC reconfiguration message 2 include starting position (in number of bit) of the cell DTX/DRX configuration activation/deactivation block within the DCI payload: serving cell index 0: starting position 0; and (6) the UE 2 monitors the PDCCH addressed to RNTI X in PDCCH monitoring occasions in search space for monitoring PDCCH for activation/deactivation of cell DTX/DRX configuration.

A gNB transmits PDCCH addressed to RNTI X. The UE 1 and the UE 2 receives the PDCCH addressed to RNTI X. The PDCCH is sent to the UE 1 and the UE 2 in non-dedicated manner: (1) the UE1 has one serving cell with serving cell index 0. cell DTX/DRX configuration activation/deactivation information block for serving cell with index 0 starts at bit 2 in DCI of PDCCH addressed to RNTI X; (2) the UE 1 activates/deactivates the cell DTX/DRX configuration for serving cell with index 0 based on information in the cell DTX/DRX configuration activation/deactivation block 2 in received DCI; (3) the UE 2 has one serving cell with serving cell index 0. cell DTX/DRX configuration activation/deactivation information block for serving cell with index 0 starts at bit 0 in DCI of PDCCH addressed to RNTI X; and (4) the UE 2 activates/deactivates the cell DTX/DRX configuration for serving cell with index 0 based on information in the cell DTX/DRX configuration activation/deactivation block 1 in received DCI.

Note that even though both the UE1 and the UE 2 has different serving cells but with same serving cell index 0, there is no ambiguity in determining the cell DTX/DRX configuration activation/deactivation block in DCI as gNB signals different starting position to the UE 1 and the UE 2 in an RRCReconfiguration message. Note that in case both the UE 1 and the UE 2 have the same serving cell, and the serving cell is a SpCell (i.e., serving cell index is zero), a gNB can signal the same starting position to both the UE1 and the UE2 in the RRCReconfiguration message.

In one embodiment, a UE receives cell DTX configuration from a gNB and configuration is activated. The UE does not continuously monitor PDCCH or SPS occasions during cell non-active periods except for PDCCH/PDSCH related to RACH, paging, and system information broadcasting. In case data or urgent data (e.g., emergency call or URLLC data) to be delivered to the UE arrives at the gNB during cell DTX non-active periods, mechanism is needed to terminate the non-active periods and inform the UE(s) in the cell as quickly as possible.

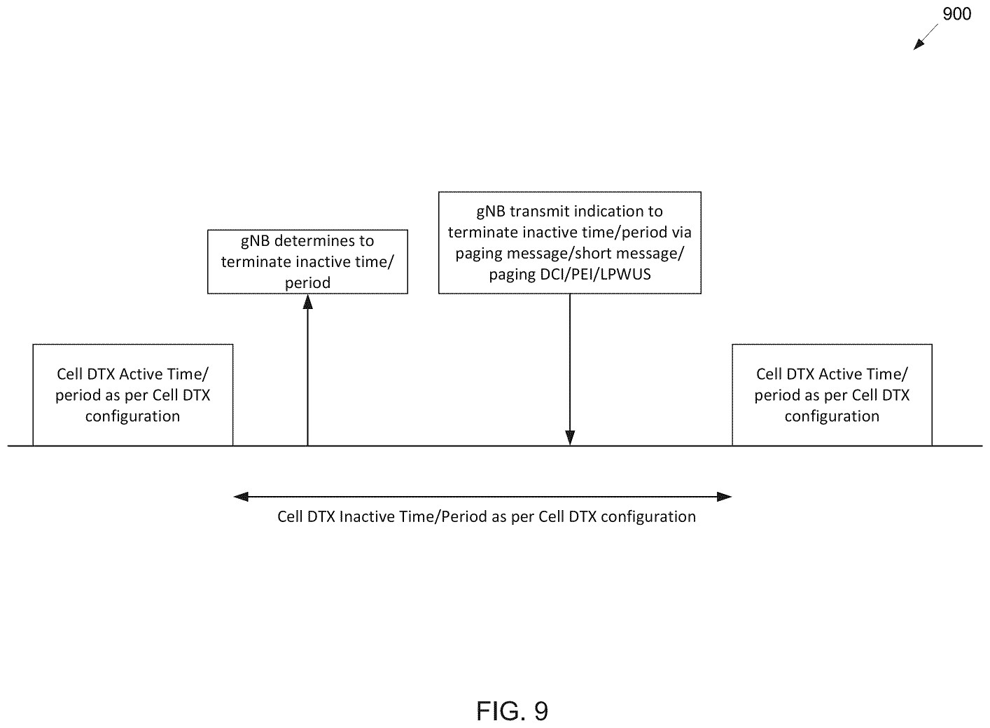

In one embodiment to terminate the non-active period, a gNB can transmit a paging message to UE(s) as shown in FIG. 9 wherein the paging message may include indication to terminate the non-active period or terminate/deactivate cell DTX configuration. The termination/deactivation indication can be for one or more cells. In one embodiment the paging message may also indicate whether indication to terminate/deactivate is for which cell (if cell is not indicated the cell is the one on which the paging message is transmitted). In one embodiment the paging message may also indicate SFN/subframe/slot from which termination/deactivation is applied (or offset with respect SFN/subframe/slot in which the paging message is received, after which termination/deactivation is applied).

In one embodiment the paging message may also indicate UTC time at/from which termination/deactivation is applied. The PDCCH for the paging message is addressed to P-RNTI and is transmitted in paging occasion. During the non-active periods, upon receiving the paging message with termination/deactivation indication for a cell, the UE terminates/deactivates the cell DTX configuration or non-active period for that cell. In one embodiment, a UE may transmit PUCCH/HARQ ACK/PUSCH/MAC CE/RACH to the gNB to confirm that the UE has received the termination/deactivation indication.

FIG. 9 illustrate an example of terminating a non-active period 900 according to embodiments of the present disclosure. An embodiment of terminating a non-active period 900 shown in FIG. 9 is for illustration only.

In one embodiment to terminate the non-active period, a gNB can transmit a short message to UE(s) as shown in FIG. 9 wherein the short message may include indication to terminate the non-active period or terminate/deactivate cell DTX configuration. The termination/deactivation indication can be for one or more cells. In one embodiment the short message may also indicate whether indication to terminate/deactivate is for which cell (if cell is not indicated the cell is the one on which the short message is transmitted).

In one embodiment the short message may also indicate SFN/subframe/slot from which termination/deactivation is applied (or offset with respect SFN/subframe/slot in which the short message is received, after which termination/deactivation is applied). In one embodiment the short message may also indicate UTC time at/from which termination/deactivation is applied. The short message may be included in DCI of PDCCH addressed to P-RNTI and is transmitted in the paging occasion or the short message can be transmitted in paging early indication. During the non-active periods, upon receiving the short message with termination/deactivation indication for a cell, a UE terminates/deactivates the cell DTX configuration or non-active period for that cell. In one embodiment, a UE may transmit PUCCH/HARQ ACK/PUSCH/MAC CE/RACH to the gNB to confirm that the UE has received the termination/deactivation indication.

In one embodiment to terminate the non-active period, a gNB can transmit paging DCI to UE(s) as shown in FIG. 9 wherein the paging DCI may include indication to terminate the non-active period or terminate/deactivate cell DTX configuration. The termination/deactivation indication can be for one or more cells. In one embodiment the paging DCI may also indicate whether indication to terminate/deactivate is for which cell (if cell is not indicated the cell is the one on which paging DCI is transmitted). In one embodiment the paging DCI may also indicate SFN/subframe/slot from which termination/deactivation is applied (or offset with respect SFN/subframe/slot in which paging DCI is received, after which termination/deactivation is applied). In one embodiment the paging DCI may also indicate UTC time at/from which termination/deactivation is applied.

The paging DCI is included in PDCCH addressed to P-RNTI and is transmitted in paging occasion or can be transmitted in paging early indication. During the non-active periods, upon receiving paging DCI with termination/deactivation indication for a cell, a UE terminates/deactivates the cell DTX configuration or non-active period for that cell. In one embodiment, a UE may transmit PUCCH/HARQ ACK/PUSCH/MAC CE/RACH to a gNB to confirm that the UE has received the termination/deactivation indication.

In one embodiment to terminate the non-active period, a gNB can transmit system information/SIB to UE(s) wherein the system information/SIB may include indication to terminate the non-active period or terminate/deactivate cell DTX configuration. The termination/deactivation indication can be for one or more cells. In one embodiment the system information/SIB may also indicate whether indication to terminate/deactivate is for which cell (if cell is not indicated the cell is the one on which system information/SIB is transmitted). In one embodiment the system information/SIB may also indicate SFN/subframe/slot from which termination/deactivation is applied (or offset with respect SFN/subframe/slot in which system information/SIB is received, after which termination/deactivation is applied).

In one embodiment the system information/SIB also indicate UTC time at/from which termination/deactivation is applied. The system information/SIB is included in PDSCH whose PDCCH is addressed to SI-RNTI and is transmitted in SI window. During the non-active periods, upon receiving system information/SIB with termination/deactivation indication for a cell, a UE may terminate/deactivate the cell DTX configuration or non-active period for that cell. In one embodiment, a UE may transmit PUCCH/HARQ ACK/PUSCH/MAC CE/RACH to a gNB to confirm that the UE has received the termination/deactivation indication.

A low power wakeup receiver (LP-WUR or LR) and wakeup signal design is being studied to minimize UE power consumption. LP-WUR or LR is a receiver module operating for receiving/processing signals/channel related to low-power wake-up. The low power wakeup receiver (LR) is expected to consume 1/100 of power consumed by main radio (also referred as main receiver (MR)) in a UE which is used to receive downlink signals (such as PDCCH, PDSCH, etc. . . . ) from a gNB. MR is the Tx/Rx module operating for signals/channels apart from signals/channel related to low-power wake-up. In one embodiment to terminate the non-active period, a gNB can transmit low power wakeup signal (LP WUS) to UE(s) as shown in FIG. 9 wherein the LP WUS may include indication to terminate the non-active period or terminate/deactivate cell DTX configuration. The termination/deactivation indication can be for one or more cells.

In one embodiment the LP WUS may also indicate whether indication to terminate/deactivate is for which cell (if cell is not indicated the cell is the one from which LP WUS is transmitted). In one embodiment the LP WUS may also indicate SFN/subframe/slot from which termination/deactivation is applied (or offset with respect SFN/subframe/slot in which LP WUS is received, after which termination/deactivation is applied). In one embodiment the LP WUS may also indicate UTC time at/from which termination/deactivation is applied. During the non-active periods, a UE monitors LP WUS using low power receiver and upon receiving LP WUS with termination/deactivation indication for a cell, a UE may terminate/deactivate the cell DTX configuration or non-active period for that cell. In one embodiment, a UE may transmit PUCCH/HARQ ACK/PUSCH/MAC CE/RACH to a gNB to confirm that the UE has received the termination/deactivation indication.

A UE receives a signaling message e.g., an RRCReconfiguration message from a gNB. The message includes separate BFD-RS set and candidate beam list for each TRP of SpCell. The message includes either 4 step CFRA (Contention free random access) or 2 step CFRA configuration for BFR of both BFD-RS sets of SpCell. The CFRA configuration is signaled per BWP per carrier. The CFRA configuration can include separate PRACH occasions and PUSCH occasions. The configuration can include list of [SSB/CSI-RS, preamble index] for 4 step CFRA, list of [SSB/CSI-RS, preamble index, PUSCH resource index] for 2 step CFRA.

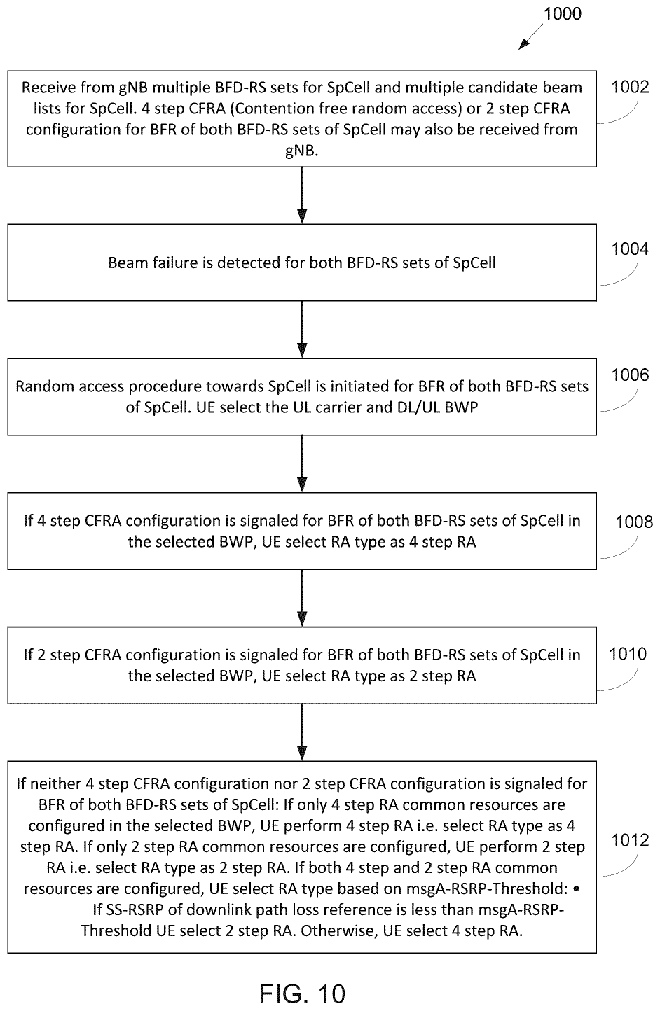

FIG. 10 illustrates a flowchart of a UE method 1000 according to embodiments of the present disclosure. The method 1000 as may be performed by a UE (e.g., 111-116 as illustrated in FIG. 1). An embodiment of the method 1000 shown in FIG. 10 is for illustration only. One or more of the components illustrated in FIG. 10 can be implemented in specialized circuitry configured to perform the noted functions or one or more of the components can be implemented by one or more processors executing instructions to perform the noted functions.

As illustrated in FIG. 10, in step 1002, the UE receives, from a gNB, multiple BFD-RS sets for SpCell and multiple candidate beam lists for SpCell. 4 step contention free random access (CFRA) or 2 step CFRA configuration for BFR of both BFD-RS sets of SpCell may also be received from gNB. In step 1004, the UE identifies that a beam failure is detected for both BFD-RS sets of SpCell. In step 1006, a random access procedure towards SpCell is initiated for BFR of both BFD-RS sets of SpCell. UE select the UL carrier and DL/UL BWP. In step 1008, if 4 step CFRA configuration is signaled for BFR of both BFD-RS sets of SpCell in the selected BWP, the UE selects RA type as 4 step RA the UE. In step 1010, if 2 step CFRA configuration is signaled for BFR of both BFD-RS sets of SpCell in the selected BWP, the UE selects RA type as 2 step RA. In step 1012, if neither 4 step CFRA configuration nor 2 step CFRA configuration is signaled for BFR of both BFD-RS sets of SpCell: if only 4 step RA common resources are configured in the selected BWP, UE perform 4 step RA i.e., select RA type as 4 step RA. f only 2 step RA common resources are configured, the UE performs 2 step RA i.e., select RA type as 2 step RA. If both 4 step and 2 step RA common resources are configured, the UE selects RA type based on msgA-RSRP-Threshold: if SS-RSRP of downlink path loss reference is less than msgA-RSRP-Threshold UE select 2 step RA. Otherwise, UE select 4 step RA.

In one embodiment, when a UE detects BFD on both TRPs (i.e., BFD-RS sets) of SpCell, the UE initiates RA procedure and select UL carrier and select DL/UL BWP for RA procedure. The UE then selects 4 step RA or 2 step RA (as shown in FIG. 10) as follows:

If 4 step CFRA configuration is signaled for BFR of both BFD-RS sets of SpCell in the selected BWP: (a) A UE selects RA type as 4 step.

If 2 step CFRA configuration is signaled for BFR of both BFD-RS sets of SpCell in the selected BWP: (a) A UE selects RA type as 2 step.

If neither 4 step CFRA configuration nor 2 step CFRA configuration is signaled for BFR of both BFD-RS sets of SpCell: (a) if only 4 step RA common resources are configured in the selected BWP, the UE performs 4 step RA i.e., select RA type as 4 step RA; (b) if only 2 step RA common resources are configured, the UE performs 2 step RA i.e., select RA type as 2 step RA; and (c) if both 4 step and 2 step RA common resources are configured, the UE selects RA type based on msgA-RSRP-Threshold: (i) if SS-RSRP of downlink path loss reference is less than msgA-RSRP-Threshold the UE selects 2 step RA. Otherwise, the UE selects 4 step RA.

If the UE selects 2 step RA, the UE selects random access resources as shown in TABLE 1.

TABLE 1
if the Random-Access procedure was initiated for beam failure recovery of both BFD-
RS sets of SpCell; and
if the 2-step contention-free Random-Access Resources for beam failure recovery of
both BFD-RS sets of SpCell, associated with any of the SSBs and/or CSI-RSs have been
received from the gNB (for selected BWP and carrier); and
if at least one of the SSBs with SS-RSRP above threshold 1 amongst the SSBs for which
2 step contention-free Random Access Resources for beam failure recovery of both
BFD-RS sets of SpCell have been received from the gNB (for selected BWP and carrier)
or the CSI-RSs with CSI-RSRP above threshold 2 amongst the CSI-RSs for which 2 step
contention-free Random Access Resources for beam failure recovery of both BFD-RS
sets of SpCell have been received from the gNB (for selected BWP and carrier) is
available:

| | |
|---|---|
| (a) | select an SSB with SS-RSRP above threshold 1 amongst the SSBs for |
| | which 2 step contention-free Random Access Resources for beam failure |
| | recovery of both BFD-RS sets of SpCell have been received from the gNB |
| | (for selected BWP and carrier) or a CSI-RS with CSI-RSRP above |
| | threshold 2 amongst the CSI-RSs for which 2 step contention-free Random |
| | Access Resources for beam failure recovery of both BFD-RS sets of SpCell |
| | have been received from the gNB (for selected BWP and carrier); |
| (b) | set the PREAMBLE_INDEX to a ra-PreambleIndex corresponding to the |
| | selected SSB or CSI-RS from 2 step contention-free Random Access |
| | Resources configuration for beam failure recovery of both BFD-RS sets of |
| | SpCell |
| (c) | select a next available PRACH occasion from the PRACH occasions |
| | corresponding to the selected SSB |
| (d) | select a PUSCH occasion from the PUSCH occasions (configured in 2 step |
| | CFRA configuration for BFR of both BFD-RS sets of SpCell), |
| | corresponding to the PRACH slot of the selected PRACH occasion, |
| | wherein the selected PUSCH occasion is according to PUSCH occasion |
| | index in 2 step CFRA configuration for BFR of both BFD-RS sets of SpCell |
| | corresponding to the selected SSB/CSI RS |

Else:

| | |
|---|---|
| (e) | select preamble randomly from 2 step contention-based preambles in 2 step |
| | RA common resources |
| (f) | select a next available PRACH occasion from the PRACH occasions |
| | (configured in 2 step RA common configuration) corresponding to the |
| | selected SSB |
| (g) | select a PUSCH occasion (from PUSCH occasions configured in 2 step RA |
| | common configuration) corresponding to the selected preamble and |
| | PRACH occasion |

A UE transmits the selected preamble in selected PRACH occasion and MsgA MAC PDU in selected PUSCH occasion. Enhanced BFR MAC CE with BFR information of failed BFD-RS sets may be included in MsgA MAC PDU.

If the UE selects 4 step RA, the UE selects random access resources as shown in TABLE 2.

TABLE 2
if the Random-Access procedure was initiated for beam failure recovery of both BFD-
RS sets of SpCell; and
if the 4-step contention-free Random-Access Resources for beam failure recovery of
both BFD-RS sets of SpCell, associated with any of the SSBs and/or CSI-RSs have been
received from the gNB (for selected BWP and carrier); and
if at least one of the SSBs with SS-RSRP above threshold 1 amongst the SSBs for which
4 step contention-free Random Access Resources have been received from the gNB (for
selected BWP and carrier) or the CSI-RSs with CSI-RSRP above threshold 2 amongst
the CSI-RSs for which 4 step contention-free Random Access Resources have been
received from the gNB (for selected BWP and carrier) is available:

| | |
|---|---|
| (a) | select an SSB with SS-RSRP above threshold 1 amongst the SSBs for |
| | which 4 step contention-free Random-Access Resources have been received |
| | from the gNB (for selected BWP and carrier) or a CSI-RS with CSI-RSRP |
| | above threshold 2 amongst the CSI-RSs for which 4 step contention-free |
| | Random-Access Resources have been received from the gNB (for selected |
| | BWP and carrier); |
| (b) | set the PREAMBLE_INDEX to a ra-PreambleIndex corresponding to the |
| | selected SSB or CSI-RS from 4 step contention-free Random Access |
| | Resources configuration for beam failure recovery of both BFD-RS sets of |
| | SpCell |

Else:

| | |
|---|---|
| (c) | select preamble randomly from 4 step contention based preambles in 4 step |
| | RA common configuration |
| (d) | select a next available PRACH occasion from the PRACH occasions |
| | (configured in 4 step RA common configuration) corresponding to the |
| | selected SSB |
| (e) | select preamble randomly from 4 step contention based preambles |

The UE transmits the selected preamble in selected PRACH occasion.

During the random access procedure, Enhanced BFR MAC CE with BFR information of failed BFD-RS sets may be included in Msg3 e.g., in UL grant received in RAR.

In one embodiment, if a UE selects 2 step RA, the UE may determine msgA-TransMax to apply (note that there can be multiple configurations of msgA-TransMax received from the gNB) during the random-access procedure to fallback from 2 step RA to 4 step RA as shown in TABLE 3.

```
TABLE 3
1> if a UE selects 2 step RA:
  2> if the Random-Access procedure was initiated for beam failure recovery of both BFD-
  RS sets of SpCell; and
  2> if 2 step CFRA configuration is configured for the selected carrier:
    3> if msgA-TransMax is configured in the 2 step CFRA configuration:
      4> apply msgA-TransMax configured in the 2 step CFRA configuration.
  2> else if msgA-TransMax is included in the 2 step RA common configuration:
    3> apply msgA-TransMax included in the 2 step RA common configuration.
```

During the 2 step RA procedure, if random access procedure is no successful after transmitting msgA-TransMax (selected above) attempts, the UE fallbacks to 4 step RA.

In one embodiment, the above procedure can also be applied for SCell.

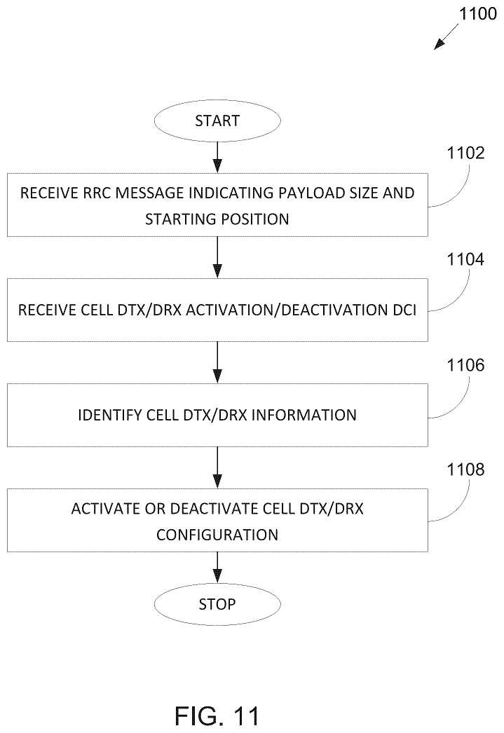

FIG. 11 illustrates a flowchart of a method 1100 for energy saving operations in a wireless communication system according to embodiments of the present disclosure. The method 1100 as may be performed by a UE (e.g., 111-116 as illustrated in FIG. 1). An embodiment of the method 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

As illustrated in FIG. 11, the method 1100 begins at step 1102. In step 1102, the UE receives, from a base station, an RRC message indicating (i) a payload size of cell DTX/DRX activation/deactivation DCI for at least one cell group and (ii) a starting position of a cell DTX/DRX information for at least one cell in DCI.

In such embodiments, the starting position of the cell DTX/DRX information is configured per serving cell.

In step 1104, the UE receives, from the base station, the cell DTX/DRX activation/deactivation DCI.

In step 1106, the UE identifies the cell DTX/DRX information for the at least one cell in the DCI based on (i) the payload size of the cell DTX/DRX activation/deactivation DCI corresponding to the at least one cell group and (ii) the starting position of the cell DTX/DRX information corresponding to the at least one cell.

In step 1108, the UE activates or deactivates a cell DTX/DRX configuration of the at least one cell based on the identified cell DTX/DRX information in the cell DTX/DRX activation/deactivation DCI.

In one embodiment, the RRC message includes a RNTI, and monitors, based on the RNTI, a PDCCH for activating or deactivating the cell DTX/DRX information. In such embodiment, the RNTI is configured per cell group.

In one embodiment, the RRC message incudes a search space identified from a list of search space configurations and monitors, based on the search space, a PDCCH for activating or deactivating the cell DTX/DRX information.

In such embodiment, the search space includes a DCI format for activating or deactivating the cell DTX/DRX information.

In one embodiment, the UE monitors, based on a search space in an active DL BWP, a PDCCH for activating or deactivating the cell DTX/DRX information indicated by a DCI format.

In one embodiment, the UE receives the DCI format from a single serving cell of a single cell group.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to:
receive, from a base station, a radio resource control (RRC) message indicating (i) a payload size of cell discontinuous transmission/reception (DTX/DRX) activation/deactivation downlink control information (DCI) for at least one cell group and (ii) a starting position of a cell DTX/DRX information for at least one cell in DCI, and
receive, from the base station, the cell DTX/DRX activation/deactivation DCI; and
a processor operably coupled to the transceiver, the processor configured to:
identify the cell DTX/DRX information for the at least one cell in the DCI based on (i) the payload size of the cell DTX/DRX activation/deactivation DCI corresponding to the at least one cell group and (ii) the starting position of the cell DTX/DRX information corresponding to the at least one cell, and
activate or deactivate a cell DTX/DRX configuration of the at least one cell based on the identified cell DTX/DRX information in the cell DTX/DRX activation/deactivation DCI.

2. The UE of claim 1, wherein the starting position of the cell DTX/DRX information is configured per serving cell.

3. The UE of claim 1, wherein:
the RRC message includes a radio network temporary identifier (RNTI);
the processor is further configured to monitor, based on the RNTI, a physical downlink control channel (PDCCH) for activating or deactivating the cell DTX/DRX information; and
the RNTI is configured per cell group.

4. The UE of claim 1, wherein:
the RRC message includes a search space identified from a list of search space configurations; and
the processor is further configured to monitor, based on the search space, a physical downlink control channel (PDCCH) for activating or deactivating the cell DTX/DRX information.

5. The UE of claim 4, wherein the search space includes a DCI format for activating or deactivating the cell DTX/DRX information.

6. The UE of claim 1, wherein the processor is further configured to monitor, based on a search space in an active downlink bandwidth part (DL BWP), a physical downlink control channel (PDCCH) for activating or deactivating the cell DTX/DRX information indicated by a DCI format.

7. The UE of claim 6, wherein the transceiver is further configured to receive the DCI format from a single serving cell of a single cell group.

8. A method of a user equipment (UE) in a wireless communication system, the method comprising:
receiving, from a base station, a radio resource control (RRC) message indicating (i) a payload size of cell discontinuous transmission/reception (DTX/DRX) activation/deactivation downlink control information (DCI) for at least one cell group and (ii) a starting position of a cell DTX/DRX information for at least one cell in DCI;
receiving, from the base station, the cell DTX/DRX activation/deactivation DCI;
identifying the cell DTX/DRX information for the at least one cell in the DCI based on (i) the payload size of the cell DTX/DRX activation/deactivation DCI corresponding to the at least one cell group and (ii) the starting position of the cell DTX/DRX information corresponding to the at least one cell; and
activating or deactivating a cell DTX/DRX configuration of the at least one cell based on the identified cell DTX/DRX information in the cell DTX/DRX activation/deactivation DCI.

9. The method of claim 8, wherein the starting position of the cell DTX/DRX information is configured per serving cell.

10. The method of claim 8, further comprising:
the RRC message includes a radio network temporary identifier (RNTI); and
monitoring, based on the RNTI, a physical downlink control channel (PDCCH) for activating or deactivating the cell DTX/DRX information,
wherein the RNTI is configured per cell group.

11. The method of claim 8, further comprising:
the RRC message includes a search space identified from a list of search space configurations; and
monitoring, based on the search space, a physical downlink control channel (PDCCH) for activating or deactivating the cell DTX/DRX information.

12. The method of claim 11, wherein the search space includes a DCI format for activating or deactivating the cell DTX/DRX information.

13. The method of claim 8, further comprising monitoring, based on a search space in an active downlink bandwidth part (DL BWP), a physical downlink control channel (PDCCH) for activating or deactivating the cell DTX/DRX information indicated by a DCI format.

14. The method of claim 13, further comprising receiving the DCI format from a single serving cell of a single cell group.

15. A base station (BS) in a wireless communication system, the BS comprising:
a processor configured to generate cell discontinuous transmission/reception (DTX/DRX) activation/deactivation downlink control information (DCI) and a cell DTX/DRX information; and
a transceiver operably coupled to the processor, the transceiver configured to:
transmit, a user equipment (UE), a radio resource control (RRC) message indicating (i) a payload size of cell DTX/DRX activation/deactivation DCI for at least one cell group and (ii) a starting position of a cell DTX/DRX information for at least one cell in DCI, and
transmit, to the UE, the cell DTX/DRX activation/deactivation DCI,
wherein the cell DTX/DRX information is identified for the at least one cell in the DCI based on (i) the payload size of the cell DTX/DRX activation/deactivation DCI corresponding to the at least one cell group and (ii) the starting position of the cell DTX/DRX information corresponding to the at least one cell, and
wherein cell DTX/DRX configuration of the at least one cell is activated or deactivated based on the identified cell DTX/DRX information in the cell DTX/DRX activation/deactivation DCI.

16. The BS of claim 15, wherein the starting position of the cell DTX/DRX information is configured per serving cell.

17. The BS of claim 15, wherein:
the RRC message includes a radio network temporary identifier (RNTI);
a physical downlink control channel (PDCCH) for activating or deactivating the cell DTX/DRX information is monitored based on the RNTI; and
the RNTI is configured per cell group.

18. The BS of claim 15, wherein:
the RRC message includes a search space identified from a list of search space configurations; and
a physical downlink control channel (PDCCH) for activating or deactivating the cell DTX/DRX information is monitored based on the search space.

19. The BS of claim 18, wherein the search space includes a DCI format for activating or deactivating the cell DTX/DRX information.

20. The BS of claim 19, wherein the transceiver is further configured to transmit the DCI format from a single serving cell of a single cell group.
